(19) United States
(12) Patent Application Publication
(10) Pub. No.: US 2026/0172416 A1
(43) Pub. Date: Jun. 18, 2026

(54) INTEGRATING DATA FROM CONNECTORS VIA A SINGLE POINT OF ENTRY

(71) Applicant: Lemon Inc., Grand Cayman (KY)

(72) Inventors: Bingyao Wang, Los Angeles, CA (US); Yuchen Zhang, Los Angeles, CA (US); Jiajun Wang, Los Angeles, CA (US)

(21) Appl. No.: 18/981,256

(22) Filed: Dec. 13, 2024

(51) Int. Cl. H04L 9/40; G06F 9/54

(52) U.S. Cl. CPC H04L 63/083; G06F 9/547

(57) ABSTRACT

Techniques for integrating data from a plurality of data connectors via a single point of entry are provided. A unique application programming interface (API) key corresponding to one of a plurality of applications is generated. An interface is caused to be presented on a client computing device associated with a user of the one of the plurality of applications. The interface is configured to provide the single point of entry for integrating data from the plurality of data connectors. A first session token is generated based on first information received from the client computing device. The first session token comprises the unique API key, an identifier of the user, and an identifier of a first data connector among the plurality of data connectors. Data is integrated to the first client computing device from the first data connector based on the first session token.

### BACKGROUND

A user can utilize a variety of different applications to perform a variety of different tasks. Each of these applications can be associated with data specific to that application. The user may desire to integrate data associated with these applications. Improved techniques for data integration are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for integrating data from a plurality of data connectors via a single point of entry in accordance with the present disclosure.

FIG. 2 shows an example process for integrating data from a plurality of data connectors via a single point of entry in accordance with the present disclosure.

FIG. 3 shows an example interface displaying a plurality of data connectors in accordance with the present disclosure.

FIGS. 4A-B show example interfaces for authenticating with a data connector in accordance with the present disclosure.

FIG. 5 shows an example interface for user selection of a data stream in accordance with the present disclosure.

FIG. 6 shows an example interface for user entry of additional set-up information in accordance with the present disclosure.

FIG. 7 shows an example process for integrating data from a plurality of connectors via a single point of entry in accordance with the present disclosure.

FIG. 8 shows an example process for integrating data from a plurality of connectors via a single point of entry in accordance with the present disclosure.

FIG. 9 shows an example process for integrating data from a plurality of connectors via a single point of entry in accordance with the present disclosure.

FIG. 10 shows an example process for integrating data from a plurality of connectors via a single point of entry in accordance with the present disclosure.

FIG. 11 shows an example process for integrating data from a plurality of connectors via a single point of entry in accordance with the present disclosure.

FIG. 12 shows an example process for integrating data from a plurality of connectors via a single point of entry in accordance with the present disclosure.

FIG. 13 shows an example computing device which may be used to perform any of the techniques disclosed herein.

### DETAILED DESCRIPTION OF ILLUSTRATIVE EMBODIMENTS

Current data integration services require partners to undergo complex data integration processes, which can include handling multiple authentication mechanisms and managing multiple API keys while ensuring secure data transmission. This complexity creates significant overhead and can increase the risk of errors during data integration. As such, improved data integration solutions are needed.

Described herein are techniques that simplify the integration process by enabling to generate a session token based on a user ID, a data connector ID, and a unique API key. Simplifying the token generation process in this manner can reduce integration time and effort. Further, security can be enhanced through assigning the unique API key and controlled access. This session token can grant access to the full package of authentication flows and data synchronization services for a variety of third-party data connectors. By providing seamless access to a comprehensive package of authentication and data integration and synchronization services, the techniques described herein significantly improve the user experience.

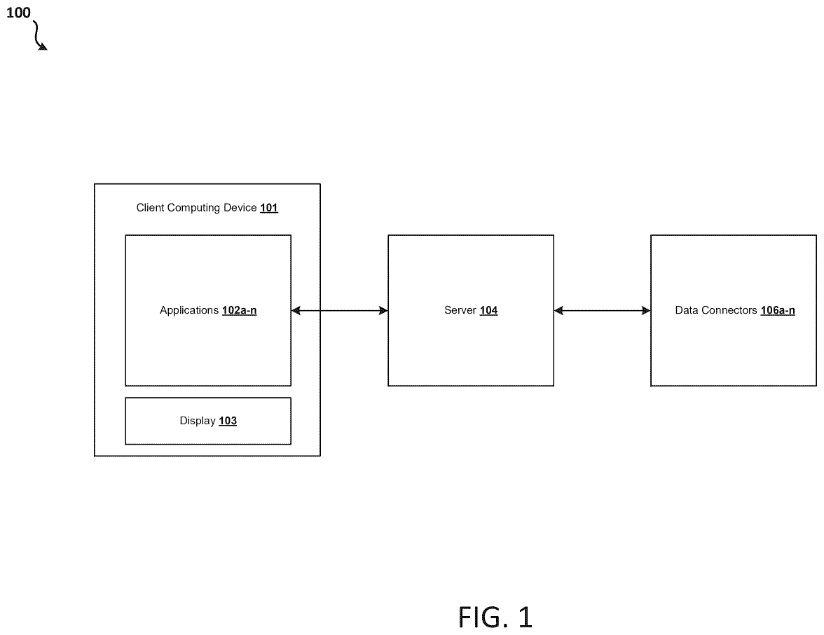

FIG. 1 shows an example system 100. The system 100 can enable the integration of data from a plurality of data connectors via a single point of entry. The system 100 can include a client computing device 101, a server 104, and a plurality of data connectors 106a-n. The client computing device 101 can be associated with a user. The client computing device 101 can include a computing device, a smart device (e.g., smart glasses, smart watch, smart phone), a mobile device, a tablet, a computing station, a laptop, a digital streaming device, a streaming stick, a television, and/or the like. The client computing device 101 can be configured to display information for user consumption via an interface or display, such as via the display 103.

A plurality of applications 102a-n can be installed on (e.g., executing on, running on) on the client computing device 101. The plurality of applications 102a-n can be associated with a first entity (e.g., a first enterprise, etc.). Each of the plurality of applications 102a-n can be associated with application-specific data.

The plurality of data connectors 106a-n can each include, correspond to, or be representative of a third-party application (e.g., an application not associated with the first entity, an application associated with a second entity). For example, the data connector 106a correspond to a first third-party application, the data connector 106b correspond to a second third-party application, and so on. The user associated with the client computing device 101 may utilize one or more of the third-party applications corresponding to the plurality of data connectors 106a-n. Each of the third-party applications can be associated with application-specific data.

The server 104 can sit between the client computing device 101 (and/or the backend server(s) associated with the plurality of applications 102a-n) and the plurality of data connectors 106a-n. The server 104 can facilitate communication between and/or the transfer of data between the client computing device 101 (and/or the backend server(s) associated with the plurality of applications 102a-n) and the plurality of data connectors 106a-n in a secure manner. The server 104 can include one or more physical computing devices, such as a server device, and/or one or more virtualized devices.

In embodiments, the user may want to integrate data from one or more third-party applications (associated with one or more of the plurality of data connectors 106a-n) with data associated with any one of the plurality of applications 102a-n. The server 104 can provide a single point of entry for integrating data from the various third-party applications (associated with the plurality of data connectors 106a-n) to any one of the plurality of applications 102a-n. For example, the client computing device 101 (and/or the backend server(s) associated with the plurality of applications 102a-n) can communicate with the server 104 to integrate data from any, or all, of the plurality of data connectors 106a-n into one or more of the plurality of applications 102a-n, without the client computing device 101 (and/or the backend server(s) associated with the plurality of applications 102a-n) needing to communicate directly with any of the plurality of data connectors 106a-n.

Any of the plurality of applications 102a-n (e.g., application 102a) (and/or backend server(s) associated with the application) can send a request, to the server 104, for access to integrate and synchronize data from third-party applications (e.g., data connectors 106a-n). The server 104 can receive the request. In response to receiving the request, the server 104 can generate a unique application programming interface (API) key. In embodiments, the unique API key can correspond to a particular application among the plurality of applications 102a-n. The unique API key can be sent, from the server 104, to the client computing device 101 on which the application (e.g., application 102a) is installed. For example, the unique API key can be sent, from the server 104, to the application (e.g., application 102a) (and/or the backend server(s) associated with the application) using a location (e.g., a uniform resource locator (URL)) indicated in the request.

The application 102a can receive the unique API key. The application 102a can send a request to register authentication (e.g., Open Authorization (OAuth)) information. The application 102a can send the request to register the authentication information to the server 104. For example, the application 102a can register its own OAuth App information. The server 104 can register the authentication information associated with the application 102a based on receiving the request to register the authentication information.

In embodiments, the server 104 can cause the client computing device 101 to present an interface (e.g., via the display 103). The interface can be configured to provide the single point of entry for integrating data from the plurality of data connectors 106a-n. For example, the interface can include a plurality of selectable elements, each of which corresponds to a particular data connector among the plurality of data connectors 106a-n. For example, the selectable element corresponding to the data connector 106a can display the name and/or identification of the data connector 106a.

In embodiments, the user can select a first selectable element among the selectable elements to initiate the integration of data from the corresponding data connector to one of the plurality of applications 102a-n. For example, the server 104 can receive an indication of the user selection of the selectable element corresponding to the data connector 106a. The server 104 can receive the indication from the client computing device 101. The server 104 can generate a first session token based on the indication received from the client computing device 101. The first session token comprises the unique API key, an identifier of the user, and an identifier of the data connector 106a.

The server 104 can send the first session token to the client computing device 101 (and/or the backend server(s) associated with the one of the applications 102a-n). The client computing device 101 (and/or the backend server(s) associated with the one of the applications 102a-n) can receive the first session token. The client computing device 101 can utilize the first session token to implement integration of data from the data connector 106a via the server 104. The server 104 can further implement data synchronization between the client computing device 101 and the data connector (e.g., data connector 106a).

In embodiments, the user can select a second selectable element among the selectable elements to initiate the integration of data from the corresponding data connector with the data associated with one or more of the plurality of applications 102a-n. For example, the server 104 can receive an indication of the user selection of the selectable element corresponding to the data connector 106b. The server 104 can receive the indication from the client computing device 101. The server 104 can generate a second session token based on the indication received from the client computing device 101. The second session token comprises the unique API key, the identifier of the user, and an identifier of the data connector 106b.

The server 104 can send the second session token to the client computing device 101 (and/or the backend server(s) associated with one of the applications 102a-n). The client computing device 101 (and/or the backend server(s) associated with one of the applications 102a-n) can receive the second session token. The client computing device 101 can utilize the second session token to cause integration of data from the data connector 106b via the server 104. The server 104 can further implement data synchronization between the client computing device 101 and the data connector 106b.

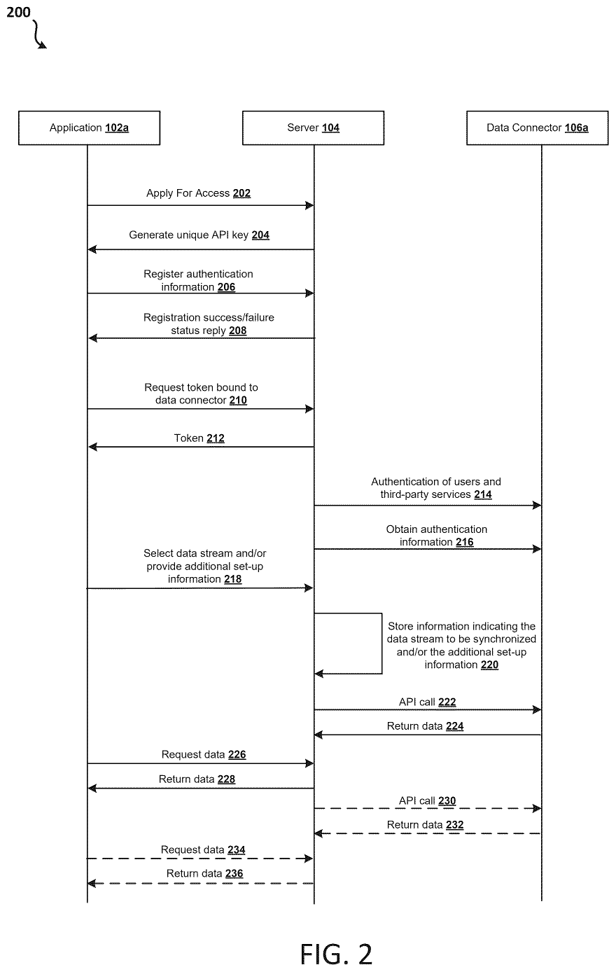

FIG. 2 shows an example process 200 for integrating data from one of data connectors (e.g., data connector 106a) via the server 104 to a client computing device (e.g., client computing device 101) on which applications (e.g., application 102a) are installed. At 202, the server 104 can receive a request for access to integrate and synchronize data from the data connector 106a. In response to receiving the request, the server 104 can generate a unique API key. The unique API key can be unique to and correspond to a particular application (e.g., application 102a). At 204, the unique API key can be sent, from the server 104, to the application 102a. For example, the unique API key can be sent, from the server 104, to the application 102a using a location (e.g., a uniform resource locator (URL)) indicated in the request.

The application 102a can receive the unique API key. At 206, the application 102a can send a request to register authentication (e.g., Open Authorization (OAuth)) information. The application 102a can send the request to register the authentication information to the server 104. For example, the application 102a can register its own OAuth App information. The server 104 can attempt to register the authentication information associated with the application 102a based on receiving the request. At 208, the server 104 can send a status reply to the application 102a. The status reply can indicate a success or failure of the registration of the authentication information.

The application 102 can send a request for a session token. At 210, the application 102a can send a request for a session token bound to the data connector 106a. The application 102a can send the request for the session token to the server 104. The server 104 can receive the request. In response to receiving the request, the server 104 can generate the session token. The session token can include the unique API key, an identifier of a user associated with the client computing device 101, and an identifier of the data connector 106a. At 212, the server 104 can send the generated session token to the application 102a.

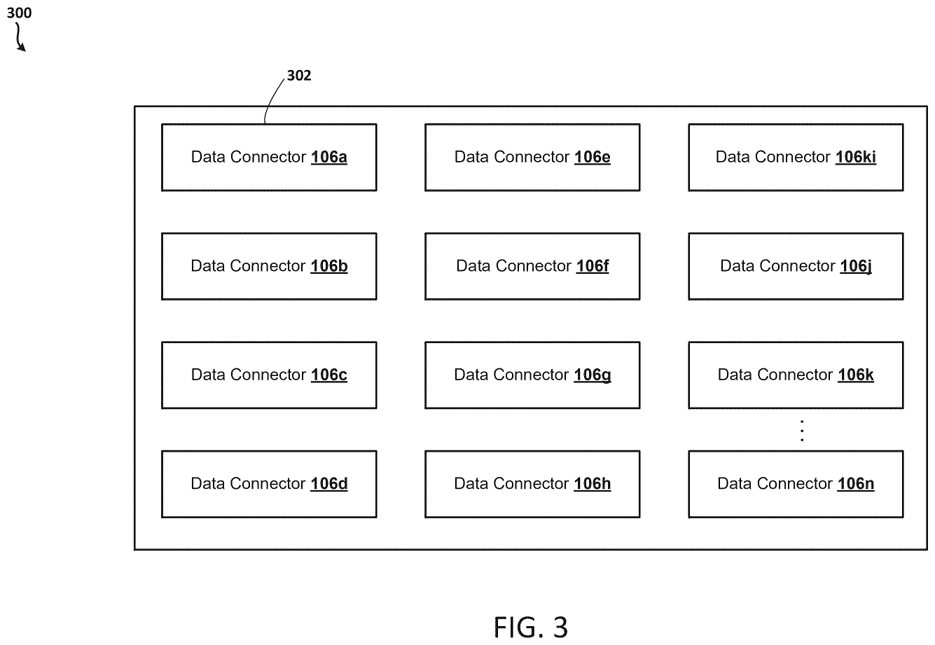

As described above, the client computing device 101 can present an interface (e.g., the interface 300 shown in FIG. 3) configured to provide a single point of entry for integrating data from the plurality of data connectors 106a-n. The interface 300 can include a plurality of selectable elements, each of which corresponds to a particular data connector among the plurality of data connectors 106a-n. If a user wants to integrate data to the application 102a from the data connector 106a via the server 104, the user can select the interface element 302.

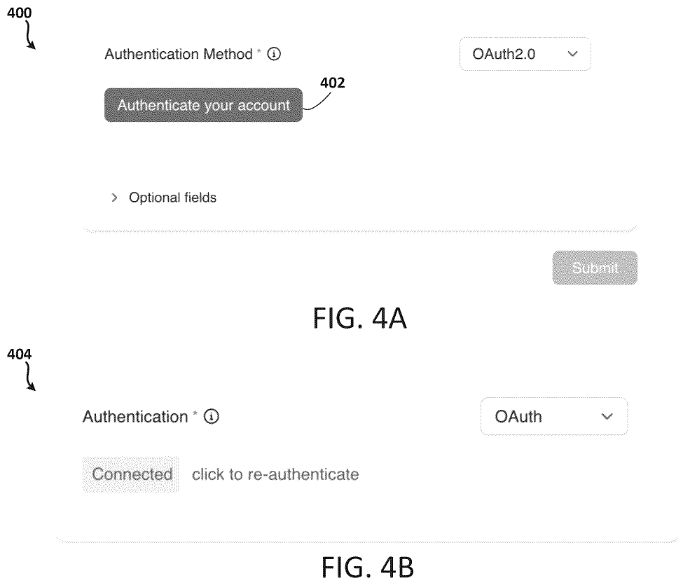

In response to the user selecting the interface element 302, the interface 400 shown in FIG. 4A can be presented (e.g., via the display 103). The user can select the interface element 402 via the interface 400. The user can provide information for authenticating to fetch data from the data connector (e.g., data connector 106a). A connection with the data connector (e.g., data connector 106a) may be established to fetch data from the data connector 106a based on the authenticating information. If the user previously provided the authenticating information for integrating data from the data connector 106a, the interface 404 illustrated in FIG. 4B can be presented to show that the connection has been established. In this case, the user does not need to provide the authenticating information again.

Referring back to FIG. 2, at 214, the authentication from the data connector 106 can be implemented based on the authenticating information provided by the user. At 216, a connection with the data connector 106a may be established for the server 104 to fetch data from the data connector 106a.

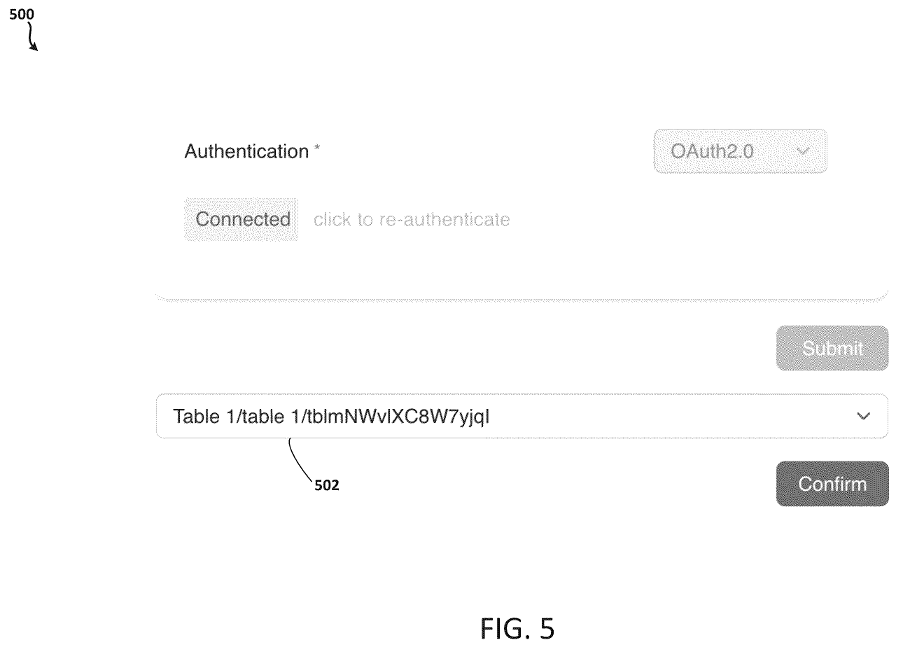

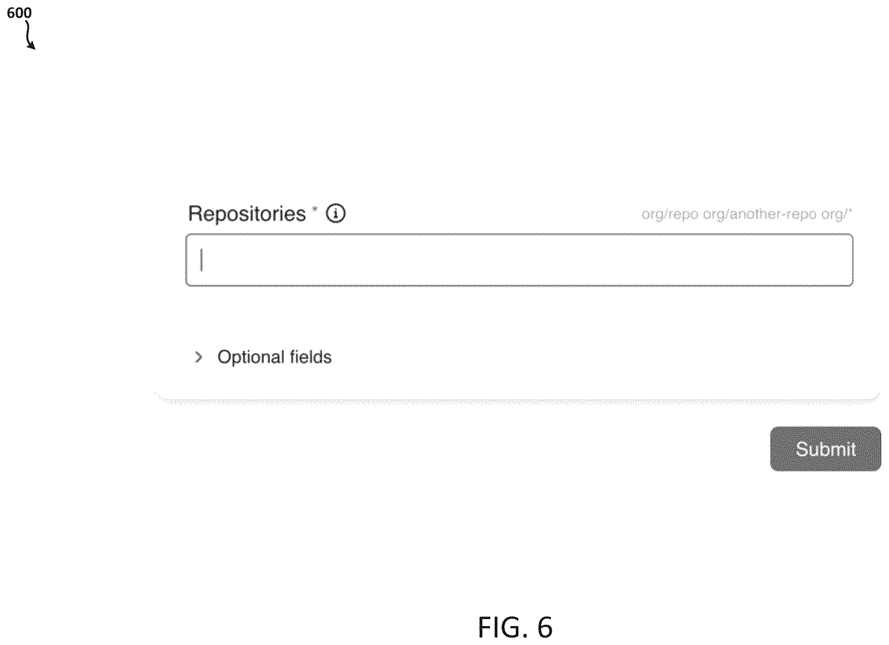

At 218, the user can select data stream(s) to be fetched from the data connector 106a. For example, the user can select the data stream 502 as shown in the interface 500 of FIG. 5. In embodiments, the user can also provide additional set-up information. For example, as shown in the interface 600 of FIG. 6, the user can provide additional set-up information that can be specific to the data connector 106a. For example, the user can specify additional information that may be required by an API associated with the data connector 106a that needs to be called in order to fetch data. The information indicating the selected data stream(s) and/or the additional set-up information can be sent to the server 104. The server 104 can receive the information indicating the selected data stream(s) and/or the additional set-up information. At 220, the server 104 can store the information indicating the selected data stream(s) and/or the additional set-up information.

The server 104 can use the stored information indicating the selected data stream(s) and/or the additional set-up information to periodically fetch data from the data connector 106a. Likewise, the application 102a can periodically request data (that has already been fetched from the data connector 106a and stored at the server 104) from the server 104. In this manner, the data can be synchronized between the data connector 106a and the application 102a on the client computing device 101.

At 222, the server 104 can send an API request to the data connector 106a for fetching data (e.g., the selected data stream) from the data connector 106a. At 224, the data connector 106a can return the data (e.g., the selected data stream) to the server 104. For example, the data connector 106a can return the selected data stream to the server 104 in response to receiving the API request. The server 104 can receive the data from the data connector 106a and store the received data at the server 104 (e.g., store the received data in one or more databases associated with the server 104). This process can be repeated periodically (e.g., every hour, every two hours, every day, etc.). For example, at 230, the server 104 can send another API request to the data connector 106a for fetching data. At 232, the data connector 106a can transmit the requested data to the server 104. For example, the data connector 106a can transmit the selected data stream to the server 104 in response to receiving the additional API request. The server 104 can receive the data from the data connector 106a and store the received data at the server 104.

The application 102a can request the selected data stream from the server 104. For example, at 226, the application 102a can request the data stream from the server 104. At 228, the server 104 can send the data stream, stored at the server 104, to the application 102a. The server 104 can send the data stream, stored at the server 104, to the application 102a in response to receiving the request from the application 102a. This process can be repeated periodically (e.g., every hour, every two hours, every day, etc.). For example, at 234, the application 102a can send another request for the data stream from the server 104. At 236, the server 104 can send the data stream, stored at the server 104, to the application 102a. The server 104 can send the data stream, stored at the server 104, to the application 102a in response to receiving the additional request from the application 102a.

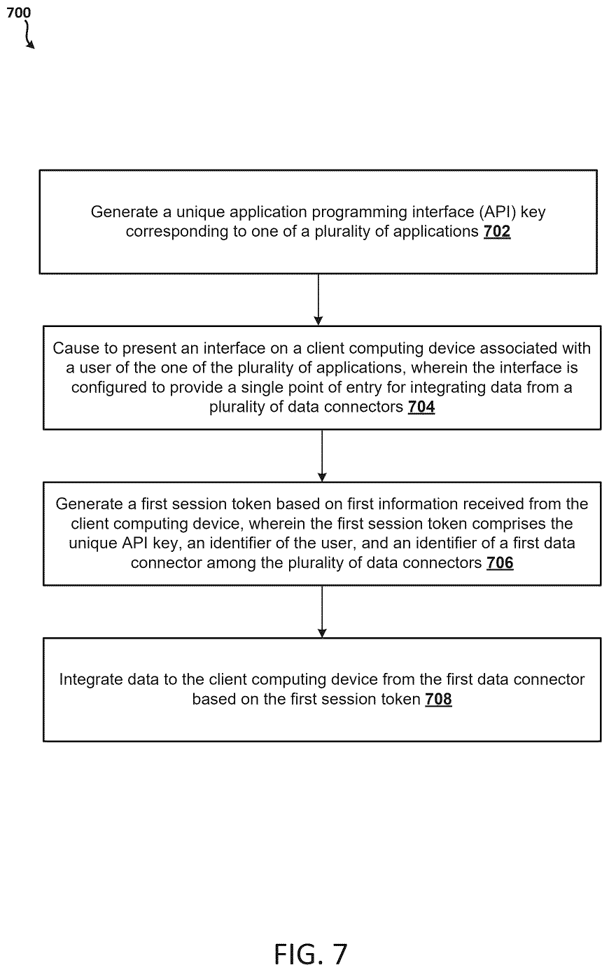

FIG. 7 shows an example process 700 for integrating data from a plurality of connectors via a single point of entry. Although depicted as a sequence of operations in FIG. 7, those of ordinary skill in the art will appreciate that various embodiments may add, remove, reorder, or modify the depicted operations.

A user may want to integrate data from a third-party application with data associated with one or more of a plurality of applications (e.g., the plurality of applications 102a-n). The third-party application can be associated with a data connector among a plurality of data connectors (e.g., data connectors 106a-n). At 702, a unique application programming interface (API) key can be generated. The unique API key can correspond to one of the plurality of applications. The unique API key can be generated by a server (e.g., server 104) that sits in between the plurality of applications and the plurality of data connectors. The unique API key can be sent to a client computing device (e.g., client computing device 101) associated with a user of the one of the plurality of applications.

At 704, an interface can be caused to be presented on the client computing device associated with the user of the one of the plurality of applications. The interface can be configured to provide a single point of entry for integrating data from the plurality of data connectors. At 706, a first session token can be generated. The first session token can be generated based on first information received from the client computing device. The first session token can include the unique API key, an identifier of the user, and an identifier of a first data connector among the plurality of data connectors. The first information received from the client computing device can include, for example, information for authenticating to fetch data from the first data connector. The first information can be received, for example, via the interface. At 708, data can be integrated to the client computing device from the first data connector. The data can be integrated to the client computing device from the first data connector based on the first session token.

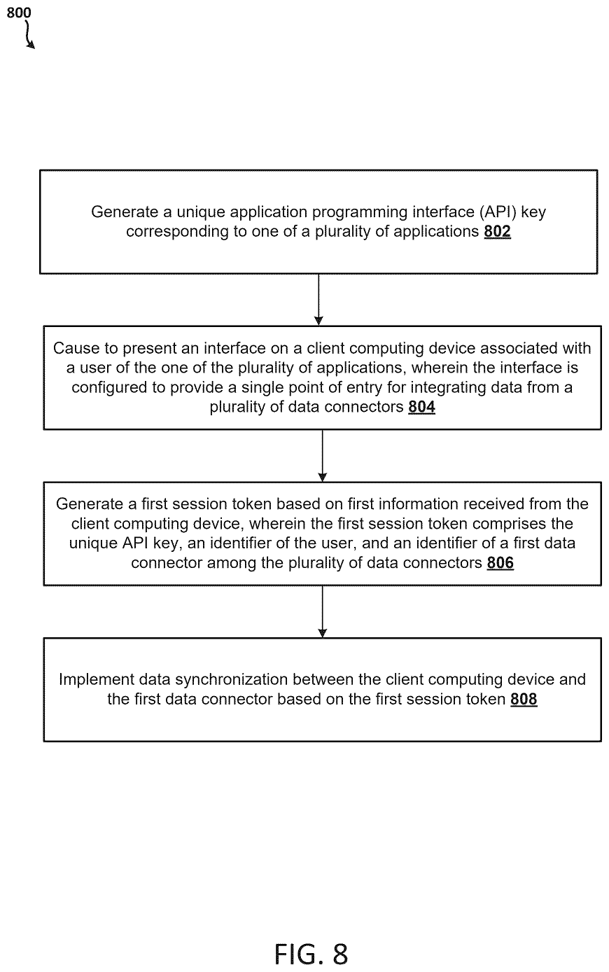

FIG. 8 shows an example process 800 for integrating data from a plurality of connectors via a single point of entry. Although depicted as a sequence of operations in FIG. 8, those of ordinary skill in the art will appreciate that various embodiments may add, remove, reorder, or modify the depicted operations.

A user may want to integrate data from a third-party application with data associated with one or more of a plurality of applications (e.g., the plurality of applications 102a-n). The third-party application can be associated with a data connector among a plurality of data connectors (e.g., data connectors 106a-n). At 802, a unique application programming interface (API) key can be generated. The unique API key can correspond to one of the plurality of applications. The unique API key can be generated by a server (e.g., server 104) that sits in between the plurality of applications and the data connector. The unique API key can be sent to a client computing device (e.g., client computing device 101) associated with a user of the one of the plurality of applications.

At 804, an interface can be caused to be presented on the client computing device associated with the user of the one of the plurality of applications. The interface can be configured to provide a single point of entry for integrating data from the plurality of data connectors. At 806, a first session token can be generated. The first session token can be generated based on first information received from the client computing device. The first session token can include the unique API key, an identifier of the user, and an identifier of a first data connector among the plurality of data connectors. The first information received from the client computing device can include, for example, information for authenticating to fetch data from the first data connector. The first information can be received, for example, via the interface. At 808, data synchronization can be implemented between the client computing device and the first data connector. The data synchronization can be implemented between the client computing device and the first data connector based on the first session token.

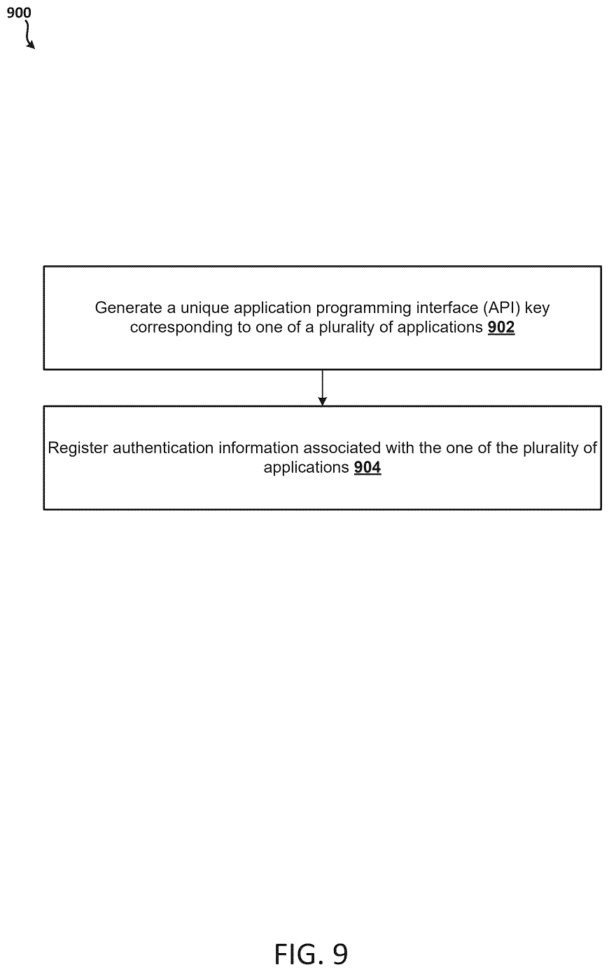

FIG. 9 shows an example process 900 for integrating data from a plurality of connectors via a single point of entry. Although depicted as a sequence of operations in FIG. 9, those of ordinary skill in the art will appreciate that various embodiments may add, remove, reorder, or modify the depicted operations.

A user may want to integrate data from a third-party application with data associated with one or more of a plurality of applications (e.g., the plurality of applications 102a-n). The third-party application can be associated with a data connector among a plurality of data connectors (e.g., data connectors 106a-n). At 902, a unique application programming interface (API) key can be generated. The unique API key can correspond to one of the plurality of applications. The unique API key can be generated by a server (e.g., server 104) that sits in between the plurality of applications and the data connector. The unique API key can be sent to a client computing device (e.g., client computing device 101) associated with a user of the one of the plurality of applications.

At 904, authentication information associated with the one of the plurality of applications can be registered. For example, the client computing device can send a request to register authentication (e.g., Open Authorization (OAuth)) information. The client computing device can send the request to register authentication information to the server. The client computing device can send the request to register authentication information based on the unique API key, an identification of the third-party application from which the user wants to integrate data, and/or user OAuth information. The server can register the authentication information associated with the application based on receiving the request to register the authentication information.

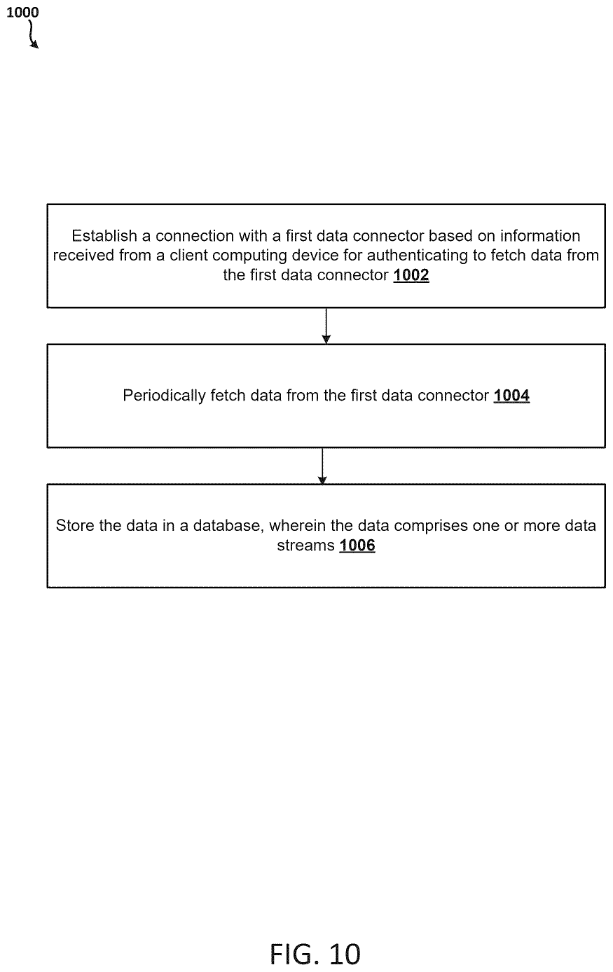

FIG. 10 shows an example process 1000 for integrating data from a plurality of connectors via a single point of entry. Although depicted as a sequence of operations in FIG. 10, those of ordinary skill in the art will appreciate that various embodiments may add, remove, reorder, or modify the depicted operations.

A user may want to integrate data from a third-party application with data associated with one or more of a plurality of applications (e.g., the plurality of applications 102a-n). The third-party application can be associated with a data connector among a plurality of data connectors (e.g., data connectors 106a-n). At 1002, a connection with the data connector (e.g., data connector 106a) can be established. The connection can be established for fetching data from the data connector. The connection can be established based on information received from a client computing device (e.g., client computing device 101). The information can be received by a server (e.g., server 104). The information comprises information for authenticating to fetch data from the data connector. At 1004, the server can periodically fetch the data from the data connector. At 1006, the data fetched from the data connector can be stored in one or more databases associated with the server (e.g., server 104). For example, the one or more databases can be local to or otherwise accessible by the server 104. The data fetched from the data connector can comprise one or mor data streams.

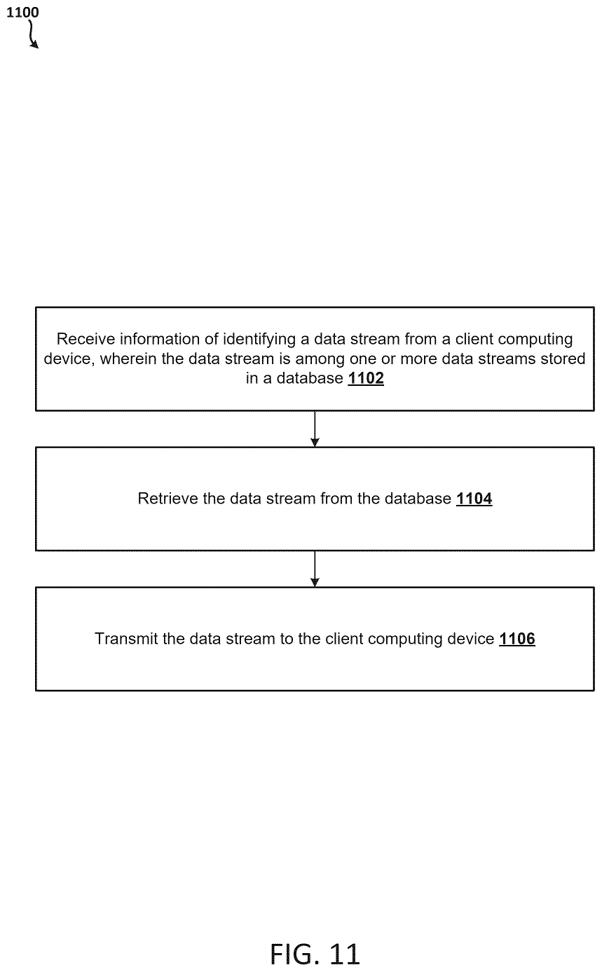

FIG. 11 shows an example process 1100 for integrating data from a plurality of connectors via a single point of entry. Although depicted as a sequence of operations in FIG. 11, those of ordinary skill in the art will appreciate that various embodiments may add, remove, reorder, or modify the depicted operations.

A user may want to integrate data, including one or more data streams, from a third-party application with data associated with one or more of a plurality of applications (e.g., the plurality of applications 102a-n). The third-party application can be associated with a data connector among a plurality of data connectors (e.g., data connectors 106a-n). At 1102, information identifying a data stream can be received. The information can be received from a client computing device (e.g., client computing device 101). The information can be received by a server (e.g., server 104). The data stream can be among one or more data streams stored in a database, such as a database local to or otherwise accessible by the server. At 1104, the data stream can be retrieved from the database. The data stream can be retrieved from the database by the server. At 1106, the retrieved data stream can be transmitted. The retrieved data stream can be transmitted to the client computing device. The retrieved data stream can be transmitted to the client computing device by the server.

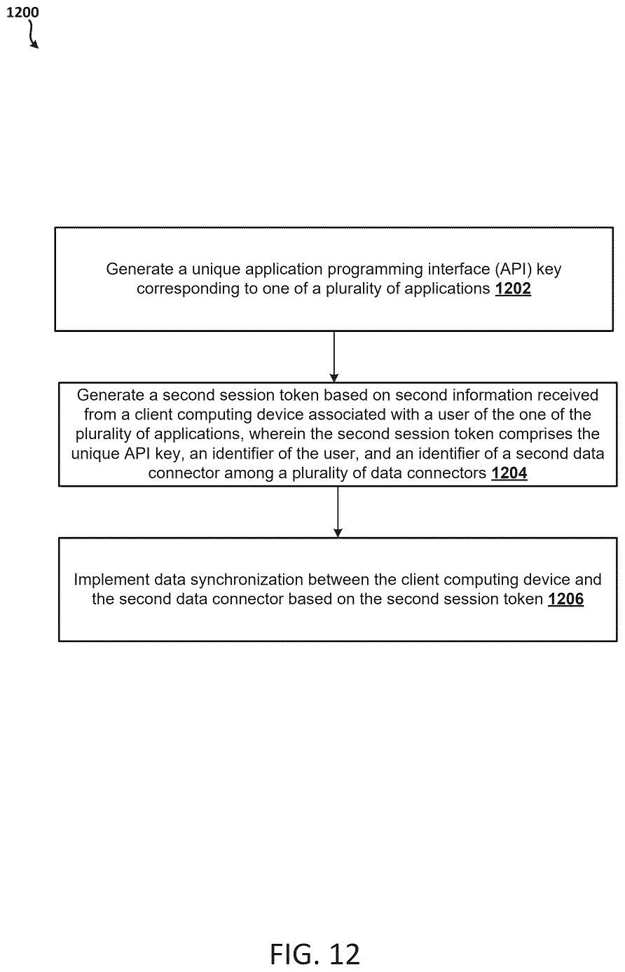

FIG. 12 shows an example process 1200 for integrating data from a plurality of connectors via a single point of entry. Although depicted as a sequence of operations in FIG. 12, those of ordinary skill in the art will appreciate that various embodiments may add, remove, reorder, or modify the depicted operations.

A user may want to integrate data from third-party applications with data associated with one of a plurality of applications (e.g., the plurality of applications 102a-n). The third-party applications can be associated with and correspond to a plurality of data connectors (e.g., data connectors 106a-n). At 1202, a unique application programming interface (API) key can be generated. The unique API key can correspond to the one of the plurality of applications (e.g., application 102a). The unique API key can be generated by a server (e.g., server 104) that sits in between the application 102a and the data connectors. The unique API key can be sent to a client computing device (e.g., client computing device 101) associated with a user of the application 102a.

At 1204, a second session token can be generated. The second session token can be generated based on second information received from the client computing device 101. The second session token can include the unique API key, an identifier of the user, and an identifier of a second data connector (e.g., data connector 106b) among the plurality of data connectors. The second information received from the client computing device can include, for example, information for authenticating to fetch data from the second data connector (e.g., data connector 106b). At 1206, data can be integrated to the client computing device from the second data connector (e.g., data connector 106b). Data synchronization between the client computing device (e.g., client computing device 101) and the second data connector (e.g., data connector 106b) can be implemented based on the second session token.

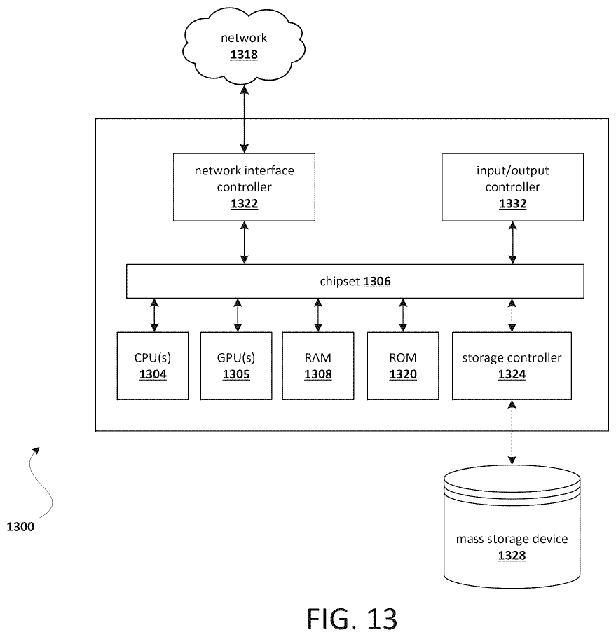

FIG. 13 illustrates a computing device that may be used in various aspects, such as the services, networks, modules, and/or devices depicted in any of FIG. 1. With regard to FIG. 1, any or all of the components may each be implemented by one or more instance of a computing device 1300 of FIG. 13. The computer architecture shown in FIG. 13 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1300 may include a baseboard, or “motherboard,” which is a printed circuit board to which a multitude of components or devices may be connected by way of a system bus or other electrical communication paths. One or more central processing units (CPUs) 1304 may operate in conjunction with a chipset 1306. The CPU(s) 1304 may be standard programmable processors that perform arithmetic and logical operations necessary for the operation of the computing device 1300.

The CPU(s) 1304 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1304 may be augmented with or replaced by other processing units, such as GPU(s) 1305. The GPU(s) 1305 may comprise processing units specialized for but not necessarily limited to highly parallel computations, such as graphics and other visualization-related processing.

A chipset 1306 may provide an interface between the CPU(s) 1304 and the remainder of the components and devices on the baseboard. The chipset 1306 may provide an interface to a random-access memory (RAM) 1308 used as the main memory in the computing device 1300. The chipset 1306 may further provide an interface to a computer-readable storage medium, such as a read-only memory (ROM) 1320 or non-volatile RAM (NVRAM) (not shown), for storing basic routines that may help to start up the computing device 1300 and to transfer information between the various components and devices. ROM 1320 or NVRAM may also store other software components necessary for the operation of the computing device 1300 in accordance with the aspects described herein.

The computing device 1300 may operate in a networked environment using logical connections to remote computing nodes and computer systems through local area network (LAN). The chipset 1306 may include functionality for providing network connectivity through a network interface controller (NIC) 1322, such as a gigabit Ethernet adapter. A NIC 1322 may be capable of connecting the computing device 1300 to other computing nodes over a network 1316. It should be appreciated that multiple NICs 1322 may be present in the computing device 1300, connecting the computing device to other types of networks and remote computer systems.

The computing device 1300 may be connected to a mass storage device 1328 that provides non-volatile storage for the computer. The mass storage device 1328 may store system programs, application programs, other program modules, and data, which have been described in greater detail herein. The mass storage device 1328 may be connected to the computing device 1300 through a storage controller 1324 connected to the chipset 1306. The mass storage device 1328 may consist of one or more physical storage units. The mass storage device 1328 may comprise a management component. A storage controller 1324 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1300 may store data on the mass storage device 1328 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1328 is characterized as primary or secondary storage and the like.

For example, the computing device 1300 may store information to the mass storage device 1328 by issuing instructions through a storage controller 1324 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1300 may further read information from the mass storage device 1328 by detecting the physical states or characteristics of one or more particular locations within the physical storage units.

In addition to the mass storage device 1328 described above, the computing device 1300 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1300.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1328 depicted in FIG. 13, may store an operating system utilized to control the operation of the computing device 1300. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1328 may store other system or application programs and data utilized by the computing device 1300.

The mass storage device 1328 or other computer-readable storage media may also be encoded with computer-executable instructions, which, when loaded into the computing device 1300, transforms the computing device from a general-purpose computing system into a special-purpose computer capable of implementing the aspects described herein. These computer-executable instructions transform the computing device 1300 by specifying how the CPU(s) 1304 transition between states, as described above. The computing device 1300 may have access to computer-readable storage media storing computer-executable instructions, which, when executed by the computing device 1300, may perform the methods described herein.

A computing device, such as the computing device 1300 depicted in FIG. 13, may also include an input/output controller 1332 for receiving and processing input from a number of input devices, such as a keyboard, a mouse, a touchpad, a touch screen, an electronic stylus, or other type of input device. Similarly, an input/output controller 1332 may provide output to a display, such as a computer monitor, a flat-panel display, a digital projector, a printer, a plotter, or other type of output device. It will be appreciated that the computing device 1300 may not include all of the components shown in FIG. 13, may include other components that are not explicitly shown in FIG. 13, or may utilize an architecture completely different than that shown in FIG. 13.

As described herein, a computing device may be a physical computing device, such as the computing device 1300 of FIG. 13. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of integrating data from a plurality of data connectors via a single point of entry, comprising:
generating a unique application programming interface (API) key corresponding to one of a plurality of applications;
causing to present an interface on a client computing device associated with a user of the one of the plurality of applications, wherein the interface is configured to provide the single point of entry for integrating data from the plurality of data connectors;
generating a first session token based on first information received from the client computing device, wherein the first session token comprises the unique API key, an identifier of the user, and an identifier of a first data connector among the plurality of data connectors; and
integrating data to the client computing device from the first data connector based on the first session token.

2. The method of claim 1, further comprising:
implementing data synchronization between the client computing device and the first data connector based on the first session token.

3. The method of claim 1, further comprising:
registering authentication information associated with the one of the plurality of applications.

4. The method of claim 1, wherein the first information received from the client computing device comprises information for authenticating to fetch data from the first data connector.

5. The method of claim 4, further comprising:
establishing a connection with the first data connector based on the information for authenticating to fetch data from the first data connector.

6. The method of claim 5, further comprising:
periodically fetching data from the first data connector; and
storing the data in a database, wherein the data comprises one or more data streams.

7. The method of claim 6, further comprising:
receiving information of identifying a data stream from the client computing device, wherein the data stream is among the one or more data streams; and
retrieving the data stream from the database and transmitting the data stream to the client computing device.

8. The method of claim 1, further comprising:
generating a second session token based on second information received from the client computing device, wherein the second session token comprises the unique API key, the identifier of the user, and an identifier of a second data connector among the plurality of data connectors.

9. The method of claim 8, further comprising:
integrating data to the client computing device from the second data connector based on the second session token; and
implementing data synchronization between the client computing device and the second data connector based on the second session token.

10. A system of integrating data from a plurality of data connectors via a single point of entry, comprising:
at least one processor; and
at least one memory communicatively coupled to the at least one processor and comprising computer-readable instructions that upon execution by the at least one processor cause the at least one processor to perform operations comprising:
generating a unique application programming interface (API) key corresponding to one of a plurality of applications;
causing to present an interface on a client computing device associated with a user of the one of the plurality of applications, wherein the interface is configured to provide the single point of entry for integrating data from the plurality of data connectors;
generating a first session token based on first information received from the client computing device, wherein the first session token comprises the unique API key, an identifier of the user, and an identifier of a first data connector among the plurality of data connectors; and
integrating data to the client computing device from the first data connector based on the first session token.

11. The system of claim 10, the operations further comprising:
implementing data synchronization between the client computing device and the first data connector based on the first session token.

12. The system of claim 10, the operations further comprising:
registering authentication information associated with the one of the plurality of applications.

13. The system of claim 10, wherein the first information received from the client computing device comprises information for authenticating to fetch data from the first data connector.

14. The system of claim 13, the operations further comprising:
establishing a connection with the first data connector based on the information for authenticating to fetch data from the first data connector;
periodically fetching data from the first data connector; and
storing the data in a database, wherein the data comprises one or more data streams.

15. The system of claim 14, the operations further comprising:
receiving information of identifying a data stream from the client computing device, wherein the data stream is among the one or more data streams; and
retrieving the data stream from the database and transmitting the data stream to the client computing device.

16. A non-transitory computer-readable storage medium, storing computer-readable instructions that upon execution by a processor cause the processor to implement operations comprising:
generating a unique application programming interface (API) key corresponding to one of a plurality of applications;
causing to present an interface on a client computing device associated with a user of the one of the plurality of applications, wherein the interface is configured to provide the single point of entry for integrating data from the plurality of data connectors;
generating a first session token based on first information received from the client computing device, wherein the first session token comprises the unique API key, an identifier of the user, and an identifier of a first data connector among the plurality of data connectors; and
integrating data to the client computing device from the first data connector based on the first session token.

17. The non-transitory computer-readable storage medium of claim 16, the operations further comprising:
implementing data synchronization between the client computing device and the first data connector based on the first session token.

18. The non-transitory computer-readable storage medium of claim 16, wherein the first information received from the client computing device comprises information for authenticating to fetch data from the first data connector.

19. The non-transitory computer-readable storage medium of claim 18, the operations further comprising:
establishing a connection with the first data connector based on the information for authenticating to fetch data from the first data connector;
periodically fetching data from the first data connector; and
storing the data in a database, wherein the data comprises one or more data streams.

20. The non-transitory computer-readable storage medium of claim 19, the operations further comprising:
receiving information of identifying a data stream from the client computing device, wherein the data stream is among the one or more data streams; and
retrieving the data stream from the database and transmitting the data stream to the client computing device.
